(19) United States
(12) Patent Application Publication
(10) Pub. No.: US 2025/0320618 A1
(43) Pub. Date: Oct. 16, 2025

(54) HYDROGEN PRODUCING DEVICE

(71) Applicant: SOLHYD, Bierbeek (BE)

(72) Inventors: Tom BOSSEREZ, Humbeek (BE); Johan MARTENS, Sint-Joris-Weert (BE); Jan RONGÉ, Overijse (BE); Pieter VERLOOY, Grimbergen (BE)

(21) Appl. No.: 18/865,022

(22) PCT Filed: May 17, 2023
(86) PCT No.: PCT/EP2023/063356

§ 371 Date: Nov. 12, 2024

(30) Foreign Application Priority Data
May 17, 2022 (EP) 22173860.2
Dec. 23, 2022 (EP) 22216431.1

(51) Int. Cl. C25B 15/08; C25B 1/042; C25B 9/015; C25B 9/05; C25B 9/23; C25B 9/65; C25B 11/031

(52) U.S. Cl. CPC C25B 15/08; C25B 1/042; C25B 9/015; C25B 9/05; C25B 9/23; C25B 9/65; C25B 11/031

(57) ABSTRACT

Hydrogen producing devices include: an inner tube with macroscopic holes. The tube has at one end an entrance opening, and at the other end an exit opening. The openings allow entrance of moist a gas and allowing exit of a gas comprising oxygen being produced in the device respectively. An electrode assembly covers the outer surface of the tube. The assembly includes an oxygen producing electrode at the inner side of the assembly, and a hydrogen producing electrode at the outer side of the assembly. The electrodes are separated from each other by a separator, a liquid or solid material with hygroscopic properties.

### FIELD OF THE INVENTION

The invention relates to novel configurations of hydrogen producing cells, typically powered by solar energy.

### BACKGROUND OF THE INVENTION

Hydrogen producing devices require the passage of large volumes of gas directly over the surface of the electrode assembly. This may lead to collapse of the electrode assembly due to overpressure in the hydrogen compartment.

### SUMMARY OF THE INVENTION

The invention relates to devices for hydrogen production comprising at least two concentric tubes, in which the inner tube is porous or water permeable and serves as a support structure for a membrane electrode assembly. Air or any other gaseous feed may be blown through the tubular device by natural or forced convection.

The device of the invention provides a solution for capturing water molecules from gaseous sources and producing and collecting hydrogen gas from these water molecules.

A tubular shape of the inner tube allows the passage of large volume flows of gas with minimal pressure drop. This enables to feed the device as well through natural convection as through forced convection with low energy consumption, such as a small ventilator.

The inner tube contains macroscopic holes to allow a gaseous source of water molecules to be in direct contact with the electrode assembly, thus enabling uptake of water molecules from said source.

A tubular shape of the inner tube furthermore allows to withstand pressure built up in the outer compartment through production of hydrogen. A minimal amount of overpressure is required to allow effective collection of the hydrogen product gas.

A tubular shape thus provides a solution for two contradicting requirements: (i) passage of large volumes of gas directly over the surface of the electrode assembly, and (ii) preventing collapse of the electrode assembly due to overpressure in the hydrogen compartment.

The device differs from prior art compared to other tubular devices for hydrogen production:

Prior art devices are based on ceramic materials for solid oxide electrolysers at elevated temperatures. In these cases, the electrodes assembly is rigid and does not risk collapse. They do not an additional inner tube.

Prior art devices exist which entirely based on liquid phases, wherein water uptake is not the aim. Therein, the electrodes are rigid metals and do not risk collapse. They do not require an additional inner tube.

Tubular assemblies of the prior art are often proposed to increase stack power density. In such case, the inner diameter must be as small as possible (<10 mm), while in the present invention a larger diameter is favourable.

The invention is further summarised in the following statements

1. A hydrogen producing device comprising:
a. An inner tube (2) with macroscopic holes, the tube having at one end an entrance opening, and at the other end an exit opening, the openings allowing entrance of moist a gas and allowing exit of a gas comprising oxygen being produced in the device respectively;
b. An electrode assembly (8) covering the outer surface of said tube, the assembly comprising an oxygen producing electrode (5) at the inner side of the assembly, and a hydrogen producing electrode (4) at the outer side of the assembly, the electrodes being separated from each other by a separator (3),
c. A liquid or solid material with hygroscopic properties.

2. The device according to statement 1, comprising a further outer tube (1) wherein said inner tube, said electrode assembly, and said hygroscopic material are located in the lumen of the outer tube, wherein the outer tube comprises an outlet for the collection of hydrogen gas being produced in the device.

3. The device according to statement 1 or 2, in which the electrodes of the assembly are connected to a power source.

4. The device according to any one of statements 1 to 3, wherein said holes have a size of between 0.1 mm2 up to 1 cm².

5. The device according to any one of statements 1 to 4, wherein the oxygen producing electrode is in contact with the surface of the inner tube.

6. The device according to any one of statements 1 to 5, comprising an element such as a blower or ventilator, for entrance of a gaseous source of water molecules into the inner tube by forced convection.

7. The device according to any one of statements 1 to 6, wherein one or both openings of the inner tube is fitted with an anti-draft valve, allowing gas to flow only in one direction.

8. The device according to any one of statements 1 to 7, wherein one or both openings of inner tube is fitted with a means, such as a gate, for mechanically shutting off and opening the inner tube.

9. The device according to any one of statements 1 to 8, wherein the separator is a non-ceramic membrane.

10. The device according to any one of statements 1 to 9, wherein the separator is an anion exchange membrane or cation exchange membrane.

11. The device according to any one of statements 1 to 10, wherein one or both electrodes are porous.

12. The device according to any one of statements 1 to 11, wherein the electrode assembly contains in addition at least one current collector.

13. The device according to any one of statements 1 to 12, wherein the electrode assembly contains in addition at least one water absorbing layer.

14. The device according to any one of statements 1 to 13, wherein the inner tube is positioned eccentric with respect to the outer tube.

15. The device according to any one of statements 1 to 14, wherein the power source is a photovoltaic device.

16. A method of producing hydrogen in a device according to any one of statements 1 to 15, comprising the step of:
allowing entrance of a gas comprising water vapor via the entrance opening of the inner tube,
converting water with electrical energy into oxygen and hydrogen, wherein produced oxygen is released at the inner side of the inner tube and produced hydrogen is released at the outer side of the inner tube,
allowing release of the oxygen via the exit opening of the inner tube, collecting the produced hydrogen generated on the outer surface of the inner tube

17. The method according to statement 16, wherein the electrical energy is provided by a device for solar energy conversion.

18. The method according to statement 16 or 17, wherein the device operates at a temperature of below 100° C.

19. The method according to any one of statements 16 to 18, wherein during operation the outer tube is at a pressure higher than ambient pressure.

20. The device according to any one of statements 16 to 19, wherein the gaseous source of water molecules is flue gas, off-gas or any other gaseous stream that is pre-treated or obtained from an industrial process.

21. The device according to any one of statements 16 to 20, wherein the gas comprising vapour is ambient air.

22. The device according to any one of statements 16 to 21, wherein the gas comprising vapour is ambient air which is introduced to the device without heating.

23. The device according to any one of statements 16 to 22, wherein the gaseous source of water molecules is fed to the device by natural convection.

24. The method according to any one of statements 16 to 23, wherein the gaseous source of water molecules is fed to the device by forced convection such as a ventilator or a fan.

### DETAILED DESCRIPTION

### Figure Legends

FIG. 1. Inner tube and outer tube

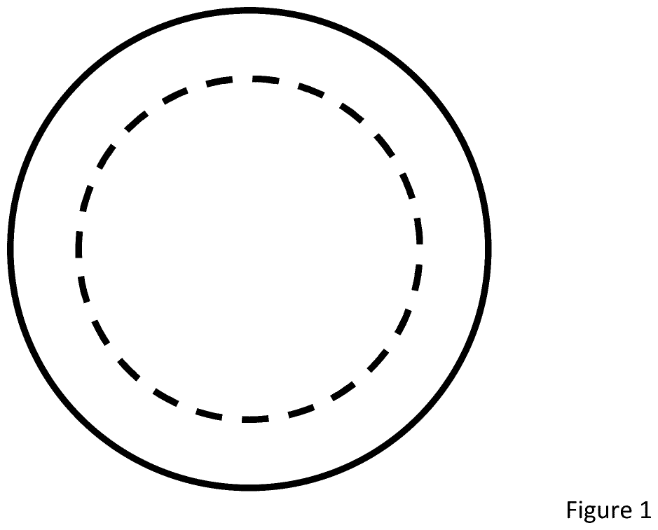

FIG. 2. Cross section of an example embodiment of the inner tube, outer tube and membrane electrode assembly

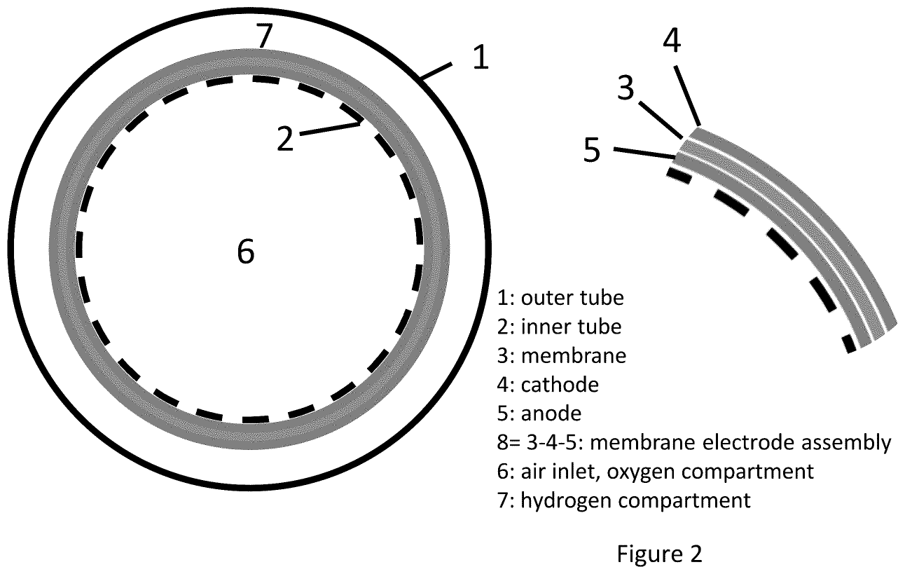

FIG. 3. Centric placement of the inner tube and membrane electrode assembly with respect to the outer tube, including a liquid phase in the outer tube

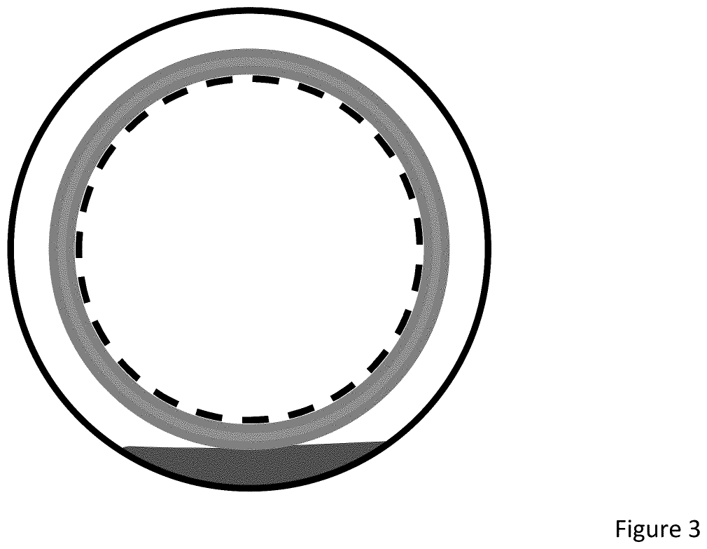

FIG. 4. Eccentric placement of the inner tube and membrane electrode assembly with respect to the outer tube, including a liquid phase in the outer tube

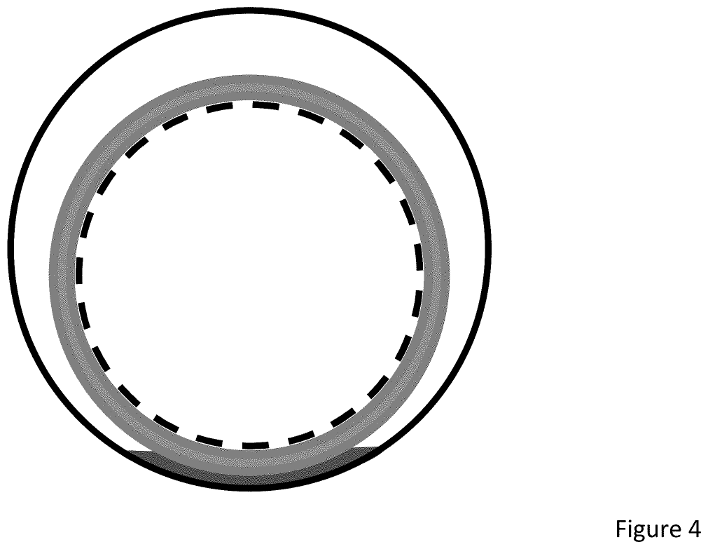

FIG. 5. Length view of one unit with length l.

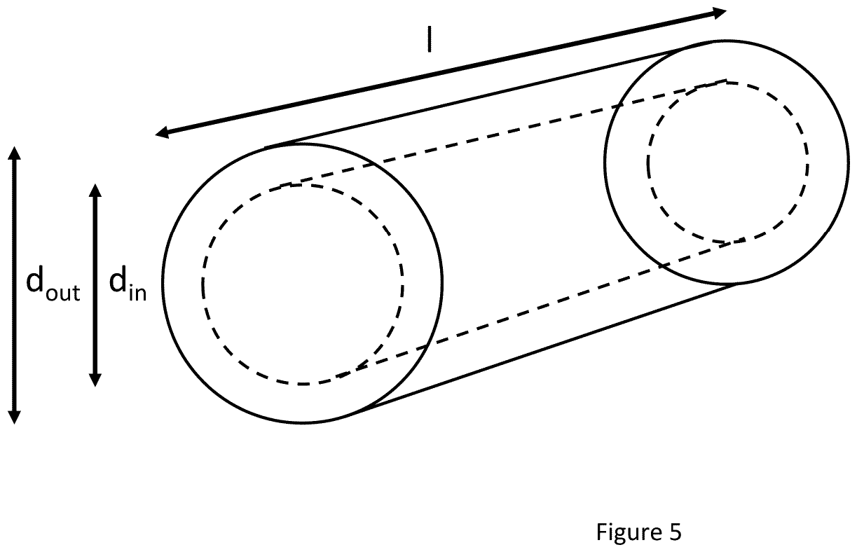

FIG. 6. Top view of multiple units with length l, connected for m units (in this example m=3) lengthwise and n units (in this example n=3) wide.

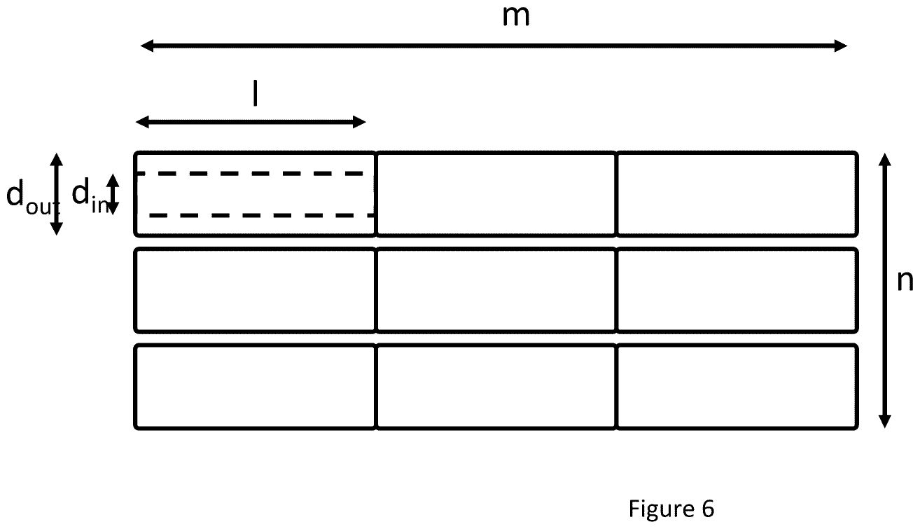

Devices of the present invention are fed with a source of water molecules. Such device consumes water molecules and produces hydrogen gas and oxygen gas. In one embodiment, the water molecules are fed as vapor by a gaseous stream. In one embodiment, ambient air is the source of water molecules. A device of the invention is connected to a power source and consumes electrical energy to produce hydrogen gas. In one embodiment, the energy is provided by a solar photovoltaic device.

One aspect of the invention relates to a combination of an outer an inner tube comprising an membrane electrode assembly.

Herein typically a gaseous feed enters and leaves the device via the inner tube. In such case, the outer tube is sealed from t and contains at least one outlet port to release produced gasses.

The membrane electrode assembly comprises at least one gas-impermeable separator (typically a ‘membrane’) and at least two electrodes, which are electrically conductive. The gas-impermeable separator is sufficiently impermeable to prevent the formation of an explosive mixture of hydrogen and oxygen. Such separator is able to permeate water molecules. Ideally, the separator is highly permeable for water molecules. The separator may also be permeable for ionic species and salts.

The electrodes may be coated with a catalytically active material. The may also possess intrinsic catalytic activity The electrodes produce gaseous products oxygen and hydrogen gas. At least one of the electrodes consumes water molecules in liquid or gaseous state, or both.

The membrane electrode assembly is wrapped around the inner tube and thus forms a tubular membrane electrode assembly. The inner tube hereby provides a support for the tubular membrane electrode assembly. The oxygen producing electrode is situated in between the gas-impermeable separator and the porous inner tube. The hydrogen producing electrode is situated in between the gas-impermeable separator and the dense outer tube. In another embodiment, the position of the electrodes is reversed. The hydrogen producing electrode are positioned in between the gas impermeable separator and a closed compartment. The oxygen producing electrode faces the compartment or tube which is fed with a gaseous stream containing water molecules.

An inner tube for use in the present invention allows the access of a gas from its interior lumen through its wall.

The inner tube generally contains macroscopic holes (at least 0.1 mm², up to 1 cm² or larger). The holes allow access of water molecules from the gaseous feed towards the membrane electrode assembly. The inner tube is characterized by a porosity (the ratio of open space to closed space). The porosity is at least 1%, ideally at least 10%, or 50%. In certain embodiments, the porosity is 90% or more. The holes may be randomly positioned along the inner tube or otherwise organized in a pattern. They may have any suitable shape. In one embodiment, the holes are slit-like. The slit-like holes may be parallel to the gas flow direction to increase water uptake. Conversely, they may be perpendicular to the gas flow direction to induce turbulence. Said hole patterns and shapes also influence the pressure resistance of the inner tube, meaning that if a pressure gradient is present between the oxygen compartment and the hydrogen compartment, the inner tube can withstand this pressure gradient and thus prevent the membrane electrode assembly from deformation. The tube typically has a pressure resistance close to ambient pressure (1 barg). In other embodiments, it has a pressure resistance of at least 1.5 barg or 2 barg. In certain embodiments, it has a pressure resistance of between 10-30 barg or more, which may facilitate downstream processing of the hydrogen product gas. The inner tube may have any suitable diameter which allows a gaseous feed to experience low pressure drop. It is typically between 10-80 mm diameter. In certain embodiments, it has a diameter as low as 1 mm, or a diameter of 200 mm and more. The inner tube diameter may be chosen to enhance the active area of the membrane electrode assembly (e.g. a larger diameter increases the area of the membrane electrode assembly). The cross-section of the inner tube is typically circular or oval, but can be any shape which is practical. It is typically positioned in the centre of the outer tube. In other embodiments, it may be positioned eccentric with respect to the outer tube. The length of the inner tube is limited only by practical considerations, such as pressure drop or space restrictions. The inner tube is further characterized by a wall thickness. A thicker wall will increase the pressure resistance, but it may reduce the access of the gaseous feed to the membrane electrode assembly. The inner tube is a support structure made of any material which is stable under the operational conditions, e.g. a synthetic polymeric or plastic material. The operational temperature is typically between −20° C. and +60° C., however it can be up to +90° C. in certain cases. environment within the outer tubes and which can come into contact with the inner tube is aqueous and may have acidic, alkaline or neutral pH.

In another embodiment, the inner tube is highly permeable material which is either dense or contains microscopic pores (<0.1 mm2).

In another embodiment the inner tube has a sponge like structure with interconnecting holes of different size.

Equally envisaged are microporous or sponge like inner tubes which further comprises macroscopic holes.

In one embodiment, the inner tube is open on both outer ends to allow free passage of air or another gaseous feed. One or both outer ends may be fitted with a means to prevent entry of insects and particles, such as a filter or grill. In another embodiment the ends may be fitted with a low pressure shield (anti draft valve) to prevent dehydration of the inner tube by natural convection but to allow easy access of air during forced convection operation.

The tube may further be fitted with a means to force a convective air flow through the device, such as a ventilator. Such ventilator may be operated from a distance or autonomously according to an algorithm. The ventilator may work with a continuous flow or pulsed flow regime, or a hybrid, to optimize the balance between energy consumption and water uptake by the device. The algorithm may work according to inputs from environmental sensors, such as temperature, relative humidity and wind speed. It could also operate according to a weather forecast. In one embodiment, the ventilator and microcontroller are fed by a battery or other means of energy storage, to render the device autonomous and independent of external inputs. The battery or other means of energy storage could in such case be recharged by a local form of energy, such as solar energy.

In another embodiment, the inner tube may be opened and closed at will. This may be achieved via louvres or a mechanically operated gate.

In yet another embodiment, the inner tube is connected to a gaseous source of water molecules by a port in the side wall at either of the outer ends. In such case, another port is required that serves as an outlet.

When the inner tube has a closing mechanism, it may be closed during hydrogen and oxygen production. During production of oxygen, the gas composition of the inner tube will converge towards high purity oxygen gas which may be captured and used. In this embodiment, the inner tube requires a release valve to prevent excessive pressure build-up, through which the oxygen gas is collected.

An outer tube for use in the present invention is a dense impermeable tube of a diameter which is larger than the inner tube. It is expected to be 20-100% larger in diameter than the inner tube, however it may have any size. An outer tube may be chosen which is much larger than the diameter of the inner tube, to increase the hydrogen capacity of the device. The outer tube is sealed from its environment as it contains hydrogen product gas. Thus, some means of sealing is required between the gas-impermeable separator wrapped around the inner tube and the outer tube material. The cross section of the outer tube is typical circular or oval shape, but can have any shape which is practical.

While the assembly of outer tube, inner tube and membrane electrode assembly allows the functioning of the device, additional features are envisaged.

The interstitial space between the outer tube and inner tube may contain a liquid phase. Said liquid acts as a buffer to supply water molecules to the membrane electrode assembly. It may be replenished by water molecules extracted from the inlet gaseous source of water molecules fed via the inner tube.

The inner tube may contain a liquid phase as well. In such case, the inner tube must be fitted with a means to prevent spillage of liquid. If the tubes are installed in a horizontal fashion, the inner tube could be fitted with baffles of any desired height, as long as spillage is avoided and the flow of the gaseous feed is not blocked entirely.

In one embodiment, the device contains desiccant materials, or hygroscopic materials, or deliquescent materials, to enhance the extraction of water molecules from the gaseous feed. Such materials may be positioned at any location inside the device, e.g. in the outer tube compartment, in the membrane electrode assembly or in the inner tube compartment.

The smallest functional unit for a solar integrated device formed the combination of one inner tube, one outer tube and one membrane electrode assembly. Such unit has a certain diameter d and length l. Multiple such units (n) may be connected along the longitudinal axis to obtain an elongated unit (m) with a total length of n×l. Multiple such elongated units (m) may be installed next to each other and/or on top of each other. The cumulative length of the entire device then amounts to m×n×l. As such an amount of m×n functional units is obtained. The functional units may be of different size, i.c. different diameter and length.

One elongated unit (m) containing n functional units is fed by a single inlet of gaseous feed, i.c. they are in series circuit connected with respect to the gaseous feed. Multiple elongated units containing m×n functional units may be fed by a single inlet of gaseous feed by means of ducts which connect the outlet of one elongated unit with the inlet of the next elongated unit. Alternatively, they may be connected in parallel and fed from different inlets of gaseous feed. As such, a minimum of 1 and a maximum of m inlets of gaseous feed are present in the entire device.

Multiple functional units may be electrically connected in series or in parallel. Multiple elongated units may be electrically connected in series or in parallel. In the case of series connection, the hydrogen producing electrode of one unit is connected with the oxygen producing electrode of the next unit. In the case of parallel connection, the hydrogen producing electrodes of the units are connected with each other, and the oxygen producing electrodes of the units are also connected with each other. In one embodiment these are physically separate and only connected electrically. In another embodiment the units can have a shared inner tube, outer tube and membrane, to simplify assembly methods and limit material use for leaking of gases at the outer tube. In this case the hydrogen and oxygen producing electrodes of one unit are spaced at a fixed distance to form distinct unit that are then connected in series electrically. The distance between units should be done in such a way that the units cannot influence each other's electric field and thus impact the oxygen and hydrogen production reactions.

The hydrogen product gas connections of multiple functional units or elongated units may be connected in series or in parallel. In a series connection, every outer tube contains at least two ports. One port is connected to the outer tube of the next unit whereas the other port is connected to the outer tube of the previous unit, by means of a tube or pipe or duct transporting the hydrogen product gas. In a parallel connection, every outer tube contains at least one port, which is connected to one joint collector tube or pipe or duct.

In one embodiment an assembly of functional units is designed to match the dimensions and electrical properties of a solar photovoltaic device. The length of the elongated units may be chosen to match the length or width of the solar photovoltaic device. The diameter of the outer tube and the amount of elongated units may be chosen to match the respective width or length of the solar photovoltaic device. The amount of series connected units may be chosen to match the operating voltage of the solar photovoltaic device. The modular fashion of connecting functional units allows to design different devices which are compatible with any solar photovoltaic device.

In one embodiment, the assembly of functional units is contained in a housing. The housing is fitted with apertures to allow a gaseous feed to enter. It may be fitted with a means to install the housing on a rack. It may be fitted with a means to allow the integration of a solar photovoltaic device. The assembly of functional units has at least two main electrical connections, which may be connected directly or indirectly with the electrical connections fitted on the solar photovoltaic device.

In another embodiment, the assembly of functional units integrated with a solar photovoltaic power source is additionally powered by an external power source, to obtain a hybrid system.

In another embodiment, the assembly of functional units integrated with a solar photovoltaic power source contains a battery or capacitor or other means of energy storage, to reduce the intermittency of hydrogen production or to reduce the peak load on the functional units. The charging and discharging of this means of energy storage may be controlled from a distance or controlled by an integrated microcontroller.

Solar-integrated devices as set forth above, are used to produce hydrogen.

This is illustrated with typical exemplary modes of operation which are non-limiting examples of the use of these de

In a first embodiment of the use of the solar integrated devices, hydrogen is produced in a day/night cycle. The device is installed outdoors. For the sake of clarity “ambient” as in ambient air or ambient pressure refers to conditions as occurring outside the device. During night-time, the inner tube is automatically fed with ambient air by wind or by a ventilator which is controlled by an algorithm and fed by a battery or other means of energy storage.

For example the ventilator could be powered by energy released from hydrogen which was produced during the day. Hydrogen in the outer tube could react with oxygen in the inner tube according to the fuel cell reaction, thus powering the ventilator directly through the membrane electrode assembly present in the device. Ambient air will pass through the inner tube and water will be extracted from it towards the membrane electrode assembly. During daytime, the inlet of the tubes is closed and the ventilator will stop operating, minimizing the convective flow inside the inner tube. The solar photovoltaic device will generate electrical power, which is used to recharge the battery or other means of energy storage, and to power the oxygen producing electrode and the hydrogen producing electrode. The oxygen product gas readily leaves the inner tube which is open to its surroundings. The hydrogen product gas builds up in the outer tube. It leaves the device at the pressure set by the release valve or, in case of a simple port, it readily leaves the device by the port. It may be collected via a tube or pipe or duct, further processed and used in any application.

In a second embodiment of the use of the solar integrated devices e hydrogen and oxygen are produced in a day/night cycle. The device is installed outdoors. During night-time, the inner tube is mechanically opened by an integrated mechanism fed by a battery or other means of energy storage. The inner tube is then fed with ambient air by a ventilator which is controlled by an algorithm and fed by a battery or other means of energy storage. Ambient air will pass through the inner tube and water will be extracted from it towards the membrane electrode assembly. During daytime, the ventilator will stop operating and the inner tube will be sealed from its environment by the integrated mechanism. The solar photovoltaic device will generate electrical power, which is used to recharge the battery or other means of energy storage, and to power the oxygen producing electrode and the hydrogen producing electrode. The oxygen product gas builds up in the inner tube. It leaves the device at the pressure set by the release valve or, in case of a simple port, it readily leaves the device by the port. It may be collected via a tube or pipe or duct, further processed and used in any application. The hydrogen product gas builds up in the outer tube. It leaves the device at the pressure set by the release valve or, in case of a simple port, it readily leaves the device by the port. It may be collected via a tube or pipe or duct, further processed and used in any application.

In a third embodiment of the use of the solar integrated devices hydrogen is produced in a continuous fashion. The device is installed anywhere near a gaseous source of water molecules, at high humidity. The inner tube is continuously fed with said gaseous source. The hydrogen producing electrode and oxygen producing electrode is continuously fed with power from an external power supply. Oxygen product gas is readily mixed and carried away with the gaseous source of water molecules as it leaves the device again. The hydrogen product gas builds up in the outer tube. It leaves the device at the pressure set by the release valve or, in case of a simple port, it readily leaves the device by the port. It may be collected via a tube or pipe or duct, further processed and used in any application.

The use of the tubular device set forth above, in which the gaseous source of water molecules is flue gas from an industrial or agricultural process.

The use of the tubular device set forth above, in which the gaseous source of water molecules is water vapor directly above a water surface such as a river, lake, sea, ocean or equivalent.

The use of the tubular device set forth above, in which the gaseous source of water molecules is indoor air from a building such as a house, an office, an event location or a swimming pool.

The use of the tubular device set forth above, in which additionally the outer tube is fed with a source of carbon dioxide, to produce hydrocarbon products.

The use of the tubular device set forth above, in which additionally the inner tube is fed with a source of carbon dioxide, which is captured and transported towards the electrode facing the outer tube, to produce hydrocarbon products.

The initialization of the device may be as follows: the device is in a dry state and installed outdoors. A desiccant or hygroscopic or deliquescent material is then added. This material may be added on-site, or it may already be contained within the device but is released and activated only upon installation. By normal functioning of the device, it will be fed with outside air. The water molecules in the air will be extracted by the desiccant or hygroscopic or deliquescent material. By physical phenomena such as diffusion, the water molecules will spread homogeneously throughout the device and bring the device towards its steady state of operation. In the case of salts or ions or other mobile species which are hygroscopic or deliquescent, such species will spread homogeneously as well without the need for intervention.

1-24. (canceled)

25. A hydrogen producing device comprising:
an inner tube with macroscopic holes, the tube having at one end an entrance opening, and at the other end an exit opening, the openings allowing entrance of moist a gas and allowing exit of a gas comprising oxygen being produced in the device respectively,
an electrode assembly covering the outer surface of said tube, the assembly comprising an oxygen producing electrode at the inner side of the assembly, and a hydrogen producing electrode at the outer side of the assembly, the electrodes being separated from each other by a separator,
a liquid or solid material with hygroscopic properties.

26. The device according to claim 25, comprising a further outer tube wherein said inner tube, said electrode assembly, and said hygroscopic material are located in the lumen of the outer tube, wherein the outer tube comprises an outlet for the collection of hydrogen gas being produced in the device.

27. The device according to claim 25, in which the electrodes of the assembly are connected to a power source.

28. The device according to claim 25, wherein said holes have a size of between 0.1 mm2 up to 1 cm2.

29. The device according to claim 25, wherein the oxygen producing electrode is in contact with the surface of the inner tube.

30. The device according to claim 25, comprising an element such as a blower or ventilator, for entrance of a gaseous source of water molecules into the inner tube by forced convection.

31. The device according to claim 25, wherein one or both openings of the inner tube is fitted with an anti-draft valve, allowing gas to flow only in one direction.

32. The device according to claim 25, wherein one or both openings of inner tube is fitted with a means, such as a gate, for mechanically shutting off and opening the inner tube.

33. The device according to claim 25, wherein the separator is any of a non-ceramic membrane, an anion exchange membrane or cation exchange membrane.

34. The device according to claim 25, wherein one or both electrodes are porous.

35. The device according to claim 25, wherein the electrode assembly contains in addition one or more of at least one current collector, at least one water absorbing layer.

36. The device according to claim 25, wherein the inner tube is positioned eccentric with respect to the outer tube.

37. The device according to claim 25, wherein the power source is a photovoltaic device.

38. A method of producing hydrogen in a device according to claim 25, comprising the step of:
allowing entrance of a gas comprising water vapor via the entrance opening of the inner tube,
converting water with electrical energy into oxygen and hydrogen, wherein produced oxygen is released at the inner side of the inner tube and produced hydrogen is released at the outer side of the inner tube, allowing release of the oxygen via the exit opening of the inner tube,
collecting the produced hydrogen generated on the outer surface of the inner tube.

39. The method according to claim 38, wherein the electrical energy is provided by a device for solar energy conversion.

40. The method according to claim 38, wherein the device operates at a temperature of below 100° C.

41. The method according to claim 38, wherein during operation the outer tube is at a pressure higher than ambient pressure.

42. The method according to claim 38, wherein the gaseous source of water molecules is flue gas, off-gas or any other gaseous stream that is pre-treated or obtained from an industrial process.

43. The method according to claim 38, wherein the gas comprising vapour is ambient air.

44. The method according to claim 38, wherein the gaseous source of water molecules is fed to the device by natural convection or by forced convection such as a ventilator or a fan.
